(19) United States
(12) Patent Application Publication
(10) Pub. No.: US 2025/0037072 A1
(43) Pub. Date: Jan. 30, 2025

(54) PRIVACY PRESERVING MULTI-AGENT DECISION MAKING

(71) Applicant: Microsoft Technology Licensing, LLC, Redmond, WA (US)

(72) Inventors: Peeyush KUMAR, Seattle, WA (US); Ananta MUKHERJEE, Bangalore (IN); Boling YANG, Seattle, WA (US); Nishanth CHANDRAN, Bengaluru (IN); Divya GUPTA, Bengaluru (IN)

(21) Appl. No.: 18/474,519

(22) Filed: Sep. 26, 2023

Related U.S. Application Data
(60) Provisional application No. 63/529,187, filed on Jul. 27, 2023.

(51) Int. Cl. G06Q 10/087; G06F 21/62

(52) U.S. Cl. CPC G06Q 10/087; G06F 21/6245

(57) ABSTRACT

The present disclosure relates to methods and systems that preserve privacy in a secure multi-party computation (MPC) framework in multi-agent reinforcement learning (MARL). The methods and systems use a secure MPC framework that allows for direct computation on encrypted data and enables parties to learn from others while keeping their own information private. The methods and systems provide a learning mechanism that carries out floating point operations in a privacy-preserving manner.

### CROSS-REFERENCE TO RELATED APPLICATIONS

This application claims priority to and the benefit of U.S. Provisional Patent Application No. 63/529,187, filed on Jul. 27, 2023, which is hereby incorporated by reference in its entirety.

### BACKGROUND

Privacy-preserving machine learning is a field that aims to develop machine learning algorithms that can train models on sensitive data without compromising privacy. Common approaches include differential privacy, which adds noise to data to preserve privacy, and federated learning, which trains models on local devices and only shares model updates, not raw data. However, attackers can potentially add hidden back doors in these models to make the models behave in a desired way.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Some implementations relate to a method. The method includes preprocessing first party data of a first party. The method includes preprocessing second party data of a second party. The method includes performing, using a secure forward pass gadget and a secure backward pass gadget in a neural network, a secure computation of the first party data and the second party data. The method includes outputting the secure computation.

Some implementations relate to a device. The device includes a processor; memory in electronic communication with the processor; and instructions stored in the memory, the instructions being executable by the processor to: preprocess first party data of a first party; preprocess second party data of a second party; perform, using a secure forward pass gadget and a secure backward pass gadget in a neural network, a secure computation of the first party data and the second party data; and output the secure computation.

Some implementations relate to a method. The method includes receiving a first state of a first party in a supply chain and an encrypted second state of a second party in the supply chain. The method includes determining, using a first neural network of the first party, an action to take in a supply chain in response to the first state and the encrypted second state. The method includes determining, using a second neural network of the first party, a reward for the action. The method includes providing the reward to the first neural network. The method includes determining, by the first neural network, a next action to take in the supply chain in response to the reward, the first state of the first party, and the encrypted second state of the second party.

Some implementations relate to a device. The device includes a processor; memory in electronic communication with the processor; and instructions stored in the memory, the instructions being executable by the processor to: receive a first state of a first party in a supply chain and an encrypted second state of a second party in the supply chain; determine, using a first neural network of the first party, an action to take in a supply chain in response to the first state and the encrypted second state; determine, using a second neural network of the first party, a reward for the action; provide the reward to the first neural network; and determine, by the first neural network, a next action to take in the supply chain in response to the reward, the first state of the first party, and the encrypted second state of the second party.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example environment for performing a secure computation using a secure forward and backward pass framework for neural networks in accordance with implementations of the present disclosure.

FIG. 2 illustrates an example of states, actions, and dynamics within a multiple party supply chain in accordance with implementations of the present disclosure.

FIG. 3 illustrates an example environment for secure multiple party deep deterministic policy gradient (MADDPG) in accordance with implementations of the present disclosure.

FIG. 4 illustrates an example method for performing secure MADDPG in accordance with implementations of the present disclosure.

FIG. 5 illustrates an example method for performing a secure computation in accordance with implementations of the present disclosure.

FIG. 6 illustrates an example method for multi-agent reinforcement learning in accordance with implementations of the present disclosure.

FIG. 7 illustrates components that may be included within a computer system.

### DETAILED DESCRIPTION

Supply chains are integral to modern commerce, ensuring the smooth transition of goods and services from production to the consumer. However, operating an efficient supply chain necessitates close coordination and decision-making among multiple organizations. In this context, each organization must often calibrate its strategies based on those of others to ensure effective operational functioning. Despite the clear advantages of such close coordination, it presents significant challenges. One concern is the sharing of private data between organizations. Sharing of data (states and actions) among supply chain organizations is vital for ensuring efficiency in a supply chain. However, in practice, many supply chain organizations are reluctant to share private data, fearing potential security risks, the possibility of unfair competitive practices, and potential regulatory and legal issues. This reluctance forms a significant barrier to the full realization of the benefits of data-driven decision-making in supply chain operations.

Privacy-preserving machine learning is a field that aims to develop machine learning algorithms that can train models on sensitive data without compromising privacy. Common approaches include differential privacy, which adds noise to data to preserve privacy, and federated learning, which trains models on local devices and only shares model updates, not raw data. However, attackers can potentially add hidden back doors in these models to make the models behave in a desired way. Another approach for secure deep learning is converting floating-point models to fixed-point models, which is not suitable for learning in large or complex multi-agent reinforcement learning (MARL) setups because of the compounding errors involved in the conversion from floating point to fixed point. Moreover, the computational intricacies inherent in reinforcement learning (RL) methods pose additional challenges when attempting to integrate secure multi-party computation techniques. Current approaches are insufficient for applications in a multi-agent setting.

The present disclosure includes several practical applications that provide benefits and/or solve problems associated with preserving privacy in a secure multi-party computation (MPC) framework in multi-agent reinforcement learning (MARL). The methods and systems use a secure MPC framework that allows for direct computation on encrypted data. Secure MPC is a protocol that facilitates joint computation over private inputs from multiple parties. Secure MPC unlocks a variety of machine-learning applications that are currently infeasible because of data privacy concerns. Secure MPC allows parties to collaboratively perform computations on their combined data sets without revealing the data they possess to each other.

The systems and methods of the present disclosure use secure MPC to enable parties to learn from others while keeping their own information private. For example, parties P₁, P₂, . . . , Pₙ (where n is a positive integer) each have secret inputs x₁, x₂, . . . , xₙ. The parties want to compute a function ƒ (x₁, x₂, . . . , xₙ) together. Ideally, a universally trusted party T calculates ƒ and shares the output with all parties. However, such a trusted entity often doesn't exist in real-life scenarios. Cryptography resolves this with MPC, which facilitates a protocol that involves regular information exchange. MPC ensures correctness (output as if computed by T) and input privacy (no additional information beyond the output is disclosed). Most MPC protocols maintain an invariant: the parties can start with secret shares of values x₁, . . . , xₙ and execute a protocol such that the parties end up with secret shares off (x₁, x₂, xₙ). This invariant is maintained for several simple functions. Once this is available for a set of functions ƒ₁, . . . , ƒₖ, these functions can be composed to compute the composition of these functions.

The systems and methods use a multi-agent deep deterministic policy gradient (MADDPG) method to simulate a scenario where each party wants to optimize towards their objectives separately and derive optimal strategies. Each party has their own objectives and use the methods and systems of the present disclosure with no exchange of private information in the clear. The methods and systems allow the MARL process to stably converge to a high-quality equilibrium through a secure usage of shared information, yet none of the parties have access to the true information of others since all shared data is encrypted.

Secure training of machine learning models often needs to compute functions such as addition, multiplication, comparisons, division, tangent, etc. While theoretically, all functions can be expressed in terms of additions and multiplications, doing so securely would be computationally expensive. The systems and methods use SECFLOAT. SECFLOAT is a secure 2PC (2 Party Computation) framework for 32-bit single-precision floating-point operations and math functions (e.g., comparison, addition, multiplication, division, and/or other transcendental functions) in an efficient manner. The SECFLOAT protocol ensures that the ULP (units in last place) errors between floating-point values obtained by elementary SECFLOAT operations, and the corresponding exact real results are less than 1, preserving the integrity of the learning algorithm the methods and systems of the present disclosure use for the machine learning models. SECFLOAT provides security against a static probabilistic polynomial time semi-honest adversary.

SECFLOAT supports both correct floating-point primitive operations (addition, multiplication, division, and comparison) and precise math functions (trigonometric functions, exponentiation, and logarithm). The functionality of SECFLOAT for operations over floats a) keeps the cryptographic cost of running the functionalities low and b) provides accurate results. The systems and methods design new crypto-friendly functionalities (operations that are cheap on clear text remain manageable in 2PC).

The systems and methods provide a learning mechanism that carries out floating point operations in a privacy-preserving manner. In some implementations, the systems and methods allow users to express functions to be computed using 2PC without requiring the users to have any cryptographic knowledge.

The systems and methods simplify the input handling and learning process of the neural network into basic operations (multiplication, addition, and comparison), which are executed using the SECFLOAT APIs (also referred to herein as SECFLOAT gadgets). The systems and methods include a forward-pass gadget (F-SECFLOAT) and a backpropagation gadget (B-SECFLOAT). The SECFLOAT gadgets enable secure computation of policy gradient methods, such as, MADDPG, overcoming limitations of previous methods. The SECFLOAT gadgets are built for a floating-point model enabling learning using MADDPG.

The B-SECFLOAT module facilitates privacy-preserving gradient optimization in the presence of strategic agents using MADDPG. Unlike previous fixed-point models, the methods and systems use a floating-point secure model based on SECFLOAT that preserves accuracy of the learning mechanism suitable for large number iterations of the backward pass.

One example use case of the methods and systems of the present disclosure is supply chains where individual strategic data must remain confidential. Organizations within the supply chain are modeled as agents, each seeking to optimize their own objectives while interacting with others. As each organization's strategy is contingent on neighboring strategies, maintaining privacy of state and action-related information is crucial. The methods and systems enhance supply chain efficiency while preserving data privacy, thereby addressing the prevalent concerns over data sharing in supply chain organizations.

Another example use case of the methods and systems of the present disclosure is using the secure data sharing for energy grid supplies. For example, an energy producer and an energy distributor use the methods and systems to interact with each other in a secure manner for determining energy grid supplies.

Another example use case of the methods and systems of the present disclosure is using the secure data sharing and computations in medical research. Another example use case of the methods and systems of the present disclosure is using the secure data sharing and computations to study gender gap in organizational salaries.

Another example use case of the methods and systems of the present disclosure is using the secure data sharing and computations for data center task management. Another example use case of the methods and systems of the present disclosure is using the secure data sharing for communication networks.

Another example use case of the methods and systems of the present disclosure is using the secure data sharing and secure computations for media and entertainment. For example, a cloud service platform uses the methods and system to exchange user data securely to an advertisement agency to receive personalized advertisements to display on the browsers of the users of the cloud service platform.

One technical advantage of the systems and methods of the present disclosure is enabling secure computations of policy gradient methods (e.g., MADDPG), while preserving privacy in a computationally feasible and more widely accessible manner. Another technical advantage of the systems and methods of the present disclosure is providing floating point capability for high level secure MADDPG operations. Another technical advantage of the systems and methods of the present disclosure is preserving accuracy of the learning mechanism suitable for large number iterations of the backward pass. Another technical advantage of the systems and methods of the present disclosure is enabling running of artificial intelligence (AI) workloads which need data sharing while preserving data privacy of the workloads.

The methods and systems of the present disclosure provide a secure multi party computation (MPC) framework using floating-point operations for policy gradient approaches, specifically MADDPG. The methods and systems of the present disclosure reduce wastage and improve revenue in industries involving multi-party decision making, leading to more efficient and secure operations, thereby, benefiting the economy and society as a whole. The methods and systems provide practical, privacy-preserving MARL and presents improvements in secure computation. The methods and systems enable previously unavailable data sharing solutions by enabling collaboration without revealing individual data.

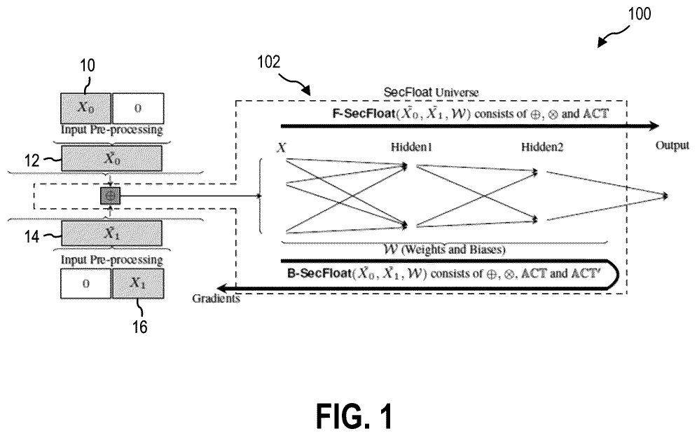

Referring now to FIG. 1, illustrated is an example environment 100 for using a secure forward and backward pass framework for neural networks to perform secure computations for dependent decision making across different organizations. The environment 100 illustrates the architecture of input distribution, pre-processing, secure computation of the forward and backward passes, and outputs of a neural network 102. While a three-layer feedforward neural network 102 is illustrated in FIG. 1, larger neural networks may be used, or different neural networks may be used with the environment 100.

In some implementations, an optimization program is used to access the environment 100 and provide the private data 10, 12 of the first party (party 0) and the private data 14, 16 of the second party (party 1) to the neural network 102. For example, the optimization program is an application on a device of a user of the environment 100. In some implementations, the neural network 102 is local to the device of the user. In some implementations, the neural network 102 is on a server (e.g., a cloud server) remote from the device of the user accessed via a network. The network may include the Internet or other data link that enables transport of electronic data between respective devices and/or components of the environment 100. For example, a uniform resource locator (URL) configured to an end point of the environment 100 is provided to the device for accessing the neural network 102.

The neural network 102 performs a secure computation on the private data 10, 12 of the first party (party 0) and the private data 14, 16 of the second party (party 1) while maintaining the privacy of the data. The neural network 102 uses private data 10, 12 of the first party and the private data 14, 16 of the second party for the secure computation. In some implementations, the private data 10, 12, 14, 16 is encrypted. The optimization program provides the output (the secure computation) from the neural network 102 to the first party (party 0) and/or the second party (party 1). The first party (party 0) and the second party (party 1) may use the output (the secure computation) of the neural network 102 to make a decision dependent on the output. For example, the first party or the second party makes decisions for a supply chain in response to the output.

One example use case of the environment 100 is food supply chains. Significant food wastage or food loss may occur during the food supply chain. One reason for the food wastage or food loss is the parties in the supply chain are unwilling to share information with each other and risk exposing private information of the parties. The parties in the food supply chain make decisions on a quantity of food to purchase from suppliers (e.g., farmers and other food suppliers) to provide to other parties in the food supply chain (e.g., restaurants or food distributors). The parties in the food supply chain also make a decision on a price to charge for the food and other supplies. For example, a first party is a food supplier, and a second party owns a restaurant and buys food from the first party. The environment 100 allows the first party and the second party to perform secure computations on the data of the first party and the second party to determine a quantity of food to purchase without disclosing private information of the parties, such as, pricing strategies of the parties.

The private data 10, 12 of the first party (party 0) and the private data 14, 16 of the second party (party 1) is illustrated is in the input pre-processing of the neural network 102. In some implementations, the private data 14, 16 of party 1 is encrypted. x^{j} is the j'^{th} row vector of X for j=1, 2, . . . , B. Each input vector in the batch, represented as x^{j}, is divided into two halves. These halves serve as secret vectors for party 0 and party 1 respectively, meaning x^{j}=x^{j}₀:∥:x^{j}₁ where xⱼ¹∈R^{d} for i=1, 2. Here ∥ is the vector concatenation operator. X₀=[xⁱ₀ ∀i∈[1,B]]_{B×d}; X₁=[xⁱ₁ ∀i∈[1,B]]_{B×d} represent the secret matrices held by party 0 and 1. Effectively X=X₀] [X₁, where] [ is the row wise matrix concatenation operator matrix concatenation operator.

A specific Party i holds all the weights and biases of the neural network 102 (i.e., W=Wᵢ). Party i receives both the forward pass prediction from the neural network 102, represented as N(X|W), and the desired gradient for the backward pass. In contrast, party (1−i) does not receive anything.

For every input vector in the batch, the first half is possessed by the party 0 and the second half is possessed by party 1. The input-preprocessing processes the input matrixes (the private data 10, 12 of the party 0 and the private data 14, 16 of the party 1) to make the input matrixes compatible for the secure forward pass gadget (API) and the secure backward pass gadget (API). The pre-processed matrixes are denoted in the figure by an overhead tilde sign. The first party (party 0) and the second party (party 1) prepare respectively, X^{˜}₀=X₀] [0^{B×d}, X^{˜}₁=0^{B×d}] [X₁, where 0^{B×d} is an all-zero matrix, which results in (X^{˜}₀+X^{˜}₁)=X.

⊕, ⊗, ACT, and ACT′ respectively denote SECFLOAT modules for matrix addition, matrix multiplication, various activation functions, and derivative of activation functions. In some implementations, the secure modules of the SECFLOAT API use a three-layer neural network for MADDPG. Let N(X|W): RB×2d→RB×z be a 3 layered feed forward neural network with input dimension 2d, output dimension z, hidden dimension h and batch size B. The layers are fully connected. W={W₁∈R^{h×2d}, b₁∈R^{1×h}, W₂∈R^{h×h}, b₂∈R^{1×h}, W₃∈R^{z×h}, b₃∈R^{1×z}} where Wᵢ and bᵢ are the weight matrix and the bias vector, respectively for the i'th layer. ƒᵢ denotes the activation function for the i'th layer, and bᵢ^{B} represent a matrix with B rows where each row is bᵢ. The forward pass for N is the equation (1) illustrated below.

$$N ( X ) = {\underbrace{{f}_{3}}}_{layer 3 Act} {\underbrace{{{[ ( {\underbrace{{f}_{2}}}_{layer 2 Act} {\underbrace{[ {{{( {\underbrace{{f}_{1}}}_{layer 1 Act} {\underbrace{[ {{X}^{⎴}}^{layer 1 / n} {W}_{1}^{T} + {b}_{1}^{B} ]}}_{layer 1 Out} )}_{⎵}}^{⎴}}^{layer 2 / n} {W}_{2}^{T} + {b}_{2}^{B} ] )}}_{layer 2 Out}}^{⎴}}^{layer 3 / n} {W}_{3}^{T} + {b}_{3}^{B} ]}}_{layer 3 Out} \qquad ( 1 )$$

For layer number i∈{1, 2, 3}: layer−i−In: Input of layer “i”, layer−i−Out: Output of layer “i”, layer−i−Act: Activation Function on top of layer “i”, layer−i−Der: Gradient of N(X) with respect to the output of layer “i” and layer−i−ActDer: Gradient of N(X) with respect to the output of the activation function on top of layer “i”. For i∈{1, 2, 3}, layer−i−In, layer−i−Out and layer−i−Act.

The neural network 102 uses a forward-pass gadget (F-SECFLOAT API) and a backpropagation gadget (B-SECFLOAT API) that may be executed by each party (party 0 and party 1). SECFLOAT ensures the security of mathematical operations, functions, and their compositions, allowing the combination of the mathematical operations in a hierarchical manner to develop secure high-level functionalities.

In some implementations, the forward pass gadget is defined by equation (2):

$$F - SecFloat ( {\tilde{X}}_{0} , {\tilde{X}}_{1} , W ) = [ RELU ( [ RELU ( ( {\tilde{X}}_{0} ⊕ {\tilde{X}}_{1} ) ⊗ {W}_{1}^{T} ⊕ {b}_{1} ) ] ⊗ {W}_{2}^{T} ⊕ {b}_{2} ) ] ⊗ {W}_{2}^{T} ⊕ {b}_{2} \qquad ( 2 )$$

where f₁ and f₂ are RELU and f₃ is identity. ⊗ and ⊕ denote the SECFLOAT APIs for matrix multiplication and addition, respectively. RELU is the ReLU API in SECFLOAT. Thus F-SECFLOAT (X^{˜}₀, X^{˜}₁, W) provides an abstraction for forward-pass in a secure manner.

In some implementations, the gradient of ReLU is ReLU′(x) and a function GetBiasDer that helps to calculate gradients with respect to biases is defined by equation (3).

$$GetBias Der ( {M}^{B} \text{?} ) = {[ {\sum }_{i = 1}^{B} {M}_{i 1} , … , {\sum }_{i = 1}^{B} {M}_{ij} , … , {\sum }_{i = 1}^{B} {M}_{i n} ]}^{1 \times n} \qquad ( 3 )$$

$$\text{?} \text{indicates text missing or illegible when filed}$$

Let ∘ denotes element wise product. By chain rule, the following systems occur in some implementations.

$$layer 3 Der = \frac{{1}^{B \times s}}{B \text{?}} \qquad ( 4 )$$

$${∇}_{{w}_{3}} N = {( layer 3 Der )}^{T} ( layer 3 In ) \qquad ( 5 )$$

$${∇}_{{b}_{0}} N = GetBias Der ( layer 3 Der ) \qquad ( 6 )$$

$$layer 2 Act Der = ( layer 3 Der ) . {W}_{3} \qquad ( 7 )$$

$$layer 2 Der = {ReLU}^{′} ( layer 2 Out ) ∘ ( layer 2 Act Der ) \qquad ( 8 )$$

$${∇}_{{w}_{2}} N = {( layer 2 Der )}^{2} ( layer 2 In ) \qquad ( 9 )$$

$${∇}_{{b}_{2}} N = GetBias Der ( layer 2 Der ) \qquad ( 10 )$$

$$layer 1 Act Der = ( layer 2 Der ) . {W}_{2} \qquad ( 11 )$$

$$layer 1 Der = {ReLU}^{′} ( layer 1 Out ) ∘ ( layer 1 Act Der ) \qquad ( 12 )$$

$${∇}_{{W}_{1}} N = {( layer 1 Der )}^{T} . ( layer 1 In ) \qquad ( 13 )$$

$${∇}_{{b}_{1}} N = GetBias Der ( layer 1 Der ) \qquad ( 14 )$$

$${∇}_{X} N = ( layer 1 Der ) . {W}_{1} \qquad ( 15 )$$

$$\text{?} \text{indicates text missing or illegible when filed}$$

In some implementations, equations (13), (14), (9), (10), (5), and (6) provide the backpropagation gadget B-SECFLOAT_{W}(X^{˜}₀, X^{˜}₁, W) for the neural network 102 that is the privacy preserving analogue of ∇_{W}N. In some implementations, equation 15 gives the API B-SECFLOAT_{X}_{^{˜}}ᵢ (X^{˜}₀, X^{˜}₁, W) analogous to ∇_{X}_{^{˜}}ᵢ N. For ∇_{W}L(N, t) where t is the target and L is the loss function, the BL-SECFLOAT_{W}(X^{˜}₀, X^{˜}₁, W, t) is provided by substituting the in equation 4 by ∇_{layer3Out} L(layer3Out, t) followed by using the equations (13), (14), (9), (10), (5), and (6). If some other network architecture is desired for the neural network 102, analogous APIs may be built using the technique provided here and the backward pass modules may be built by analyzing the chain rule, using the template defined in equations (13), (14), (9), (10), (5), (6), and (15) for back propagation of the neural network.

In some implementations, one or more computing devices (e.g., servers and/or devices) are used to perform the processing of the environment 100. The one or more computing devices may include, but are not limited to, server devices, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. Another example includes one or more subcomponents of the features and functionalities discussed herein in connection with the various systems may be implemented across multiple computing devices. Moreover, in some implementations, one or more subcomponent of the features and functionalities discussed herein in connection with the various systems may be implemented are processed on different server devices of the same or different cloud computing networks.

In some implementations, each of the components of the environment 100 is in communication with each other using any suitable communication technologies. In addition, while the components of the environment 100 are shown to be separate, any of the components or subcomponents may be combined into fewer components, such as into a single component, or divided into more components as may serve a particular implementation. In some implementations, the components of the environment 100 include hardware, software, or both. For example, the components of the environment 100 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 100 include hardware, such as a special purpose processing device to perform a certain function or group of functions. In some implementations, the components of the environment 100 include a combination of computer-executable instructions and hardware.

The environment 100 enables data exchange between multiple parties so that the multiple parties may use the data in making dependent decisions while preserving a privacy of the data. In some implementations, the environment 100 is used to reduce waste in supply chains. In some implementations, the environment 100 is used to increase efficiency in supply chains.

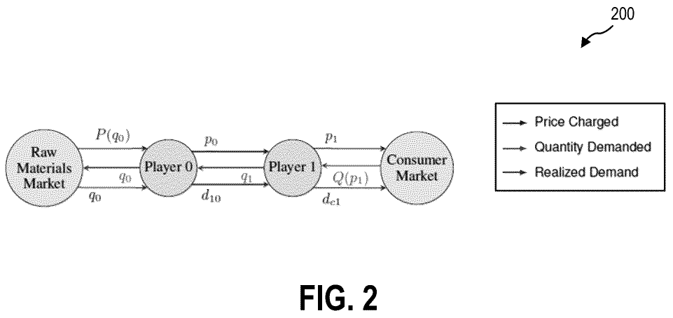

Referring now to FIG. 2, illustrated is an example of states, actions, and dynamics within a multiple party supply chain 200 at a given time stamp t. The multiple party supply chain 200 includes two parties, party zero and party one interacting between the raw materials market and the consumer market. The multiple party supply chain 200 illustrates the price charged, the quantity demanded, and the realized demand.

In some implementations, the states are the forecasted cost/demand, the actions are the price for unit product and quantity of raw material. For example, the consumer market demand is Q(p₁), a function of price charged, and the raw material price is P(q₀), a function of quantity demanded.

In some implementations, party i's internal state is sᵢ=[cᵢ, μᵢ, xᵢ, yᵢ]. cᵢ∈R₊ is the purchasing cost per unit product from i's supplier. μᵢ∈R₊ is the demand anticipated by party i from their retailer. The current stock level of party i is xᵢ∈R₊ and the incoming stock replenishment in the next lᵢ time steps is yᵢ R^{l}i. Time t, [yᵢ(t)]ₙ is the replenishment that arrives at time t+n.

In some implementations, party i's action is aᵢ=[qᵢ, pᵢ]. qᵢ R₊ is the quantity of product that party i decides to purchase from her supplier and pᵢ R₊ is the price per unit product that party i decides to charge from their retailer. If party i receives a total order of Dᵢ to supply and xᵢ is their current stock level, in the two-player setup, realized demand by party i is given by dᵢ=min(Dᵢ, xᵢ). Anticipated demand is computed on the basis of historical demand trends i.e., μᵢ(t)=ƒᵢ(Dᵢ(0), Dᵢ(1), . . . , Dᵢ(t−1)) where ƒᵢ is a suitable forecasting method. The stock level at time t+1 is given by, xᵢ(t+1)=xᵢ(t)−dᵢ(t)+[yᵢ(t)]₁. The incoming stock replenishment transitions are given by [yᵢ(t+1)]ₖ=[yᵢ(t)]ₖ₊₁ for k=1, 2, . . . , lᵢ−1. The last incoming replenishment [yi(t+1)]lᵢ is the available supply from party i's supplier.

In some implementations, after a specific transition, the total reward of party i is illustrated by equation (16)

$${r}_{i} ( t ) = {\underbrace{{p}_{i} ( t ) {d}_{i} ( t )}}_{Total Revenue} - {\underbrace{{c}_{i} ( t ) {z}_{i} ( t )}}_{Total Purchasing Cost} - {\underbrace{{h}_{i} ( {x}_{i} ( t ) - {d}_{i} ( t ) )}}_{Handling Cost} - {\underbrace{{w}_{i} ( {D}_{i} ( t ) - {d}_{i} ( t ) ) ,}}_{Loss of Goodwill Cost} \qquad ( 16 )$$

where hᵢ, wᵢ∈R₊ are proportionality constants, and zᵢ is the quantity delivered by party i's supplier. Party 0 and party 1 solve for different reward structures.

Since player 0 fully gets their ordered quantity (q0) delivered from the raw materials market, the quantity procured by this supply chain equals q0. Party 1 delivers a quantity of dc1 to the consumer market. The wastage due to this supply chain can be characterized as (q0−dc1). For a healthy supply chain, this wastage should be as low as possible. Each party engages in a stochastic asymmetric information game through a Markov Decision Processes (MDP) where each party intends to find an optimal policy for an MDP (Sᵢ, Aᵢ, Pᵢ, Rᵢ, γᵢ). For player i, Sᵢ is the set of valid states, Aᵢ is the set of all valid actions, Pᵢ and Rᵢ are the transition probability and reward functions, and γᵢ is discount factor in time.

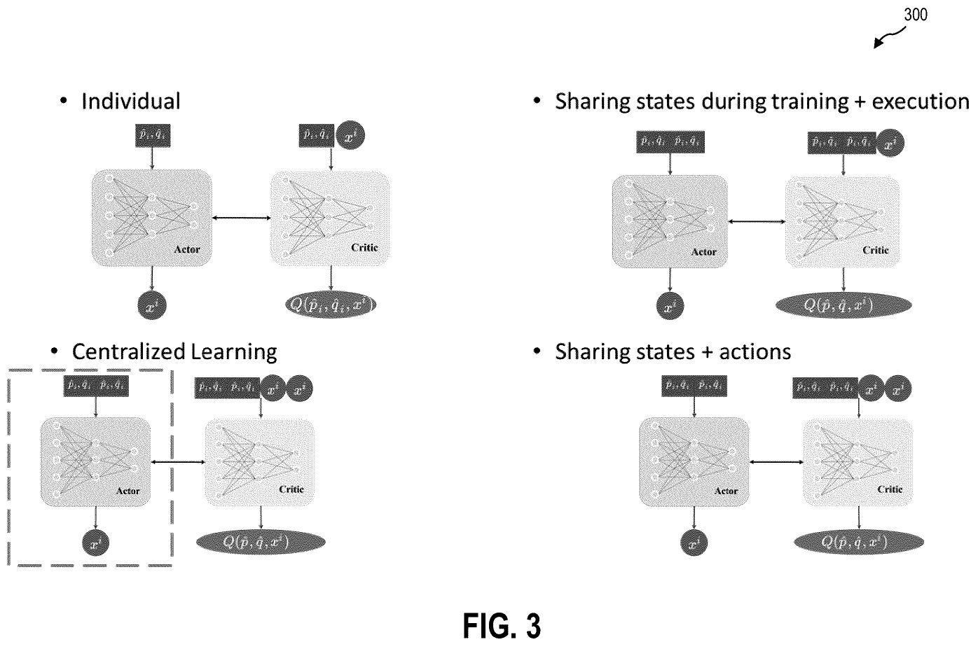

Referring now to FIG. 3, illustrated is an example environment 300 for secure MADDPG. MADDPG is an extension of Deep Deterministic Policy Gradient (DDPG), which is a policy-based reinforcement learning algorithm. MADDPG differs from DDPG by catering to multi-agent environments where multiple learning agents interact with each other. In a MADDPG setup with mutual information sharing, four neural networks exist for each party i, namely Actor (πᵢ), Critic(Qᵢ), Actor Target (πi′) and Critic Target (Q′i). The neural networks are parameterized by θᵢ, ϕᵢ, θi′ and ϕ′i respectively. The actor neural network is updated by the critic neural network. The critic neural network evaluates the action chosen by the action neural network and provides a value (a reward) associated with the action.

In some implementations, there are two parties in the environment 300 interacting with each other. One actor neural network and one critic neural network exists for each party. For party i, apart from their own states and actions sᵢ and aᵢ, the states and actions of the other party (i.e., s₁₋ᵢ and a₁₋ᵢ) are also accessible. Under those circumstances, party i picks up their action according to aᵢ=πᵢ(sᵢ, s₁₋ᵢ|θᵢ). The Critic Network, Qᵢ gives the expected reward for party i if party i starts from state and action sᵢ and aᵢ for i∈{0, 1} both and then party i forever follows a trajectory τ according to their current policy. The expected reward is given by Qᵢ(sᵢ, aᵢ, s₁₋ᵢ, a₁₋ᵢ|ϕᵢ). Actor Target and Critic Target networks are π′ᵢ(., .|θ′ᵢ) and Q′ᵢ(., ., ., .|ϕ′ᵢ) respectively. When party i for i∈{0, 1} both, makes a transition from a state sᵢ to s′ᵢ by an action aᵢ with a reward rᵢ, the target expected return is updated independently as Q^{targ}(rᵢ, s′ᵢ)=rᵢ+γQ′ᵢ(s′ᵢ, π′ᵢ(s′ᵢ, s′₁₋ᵢ|θ′), s′₁₋ᵢ, π′₁₋ᵢ(s′₁₋ᵢ, s′ᵢ|θ′₁₋ᵢ)|ϕ′i).

For a mini batch of transitions Bi={(si, ai, ri, s′i)k} (for k=1, 2, . . . , |B|) both with the sampling randomness being the same for both B0 and B1, the gradient of the MSBE (Mean squared Bellman Error) is illustrated in equation (17).

$${∇}_{{ϕ}_{s}} L = \frac{2}{\vert {B}_{i} \vert} {\sum }_{\text{?}} [ ( {Q}_{i} ( {s}_{i} , {a}_{i} , s \text{?} {a}_{1 - i} \vert {ϕ}_{s} ) - {Q}_{i}^{targ} ( {r}_{i} , \text{?} ) ) ∇ \text{?} {Q}_{i} ( {s}_{i} , {a}_{i} {s}_{1 - i} , {a}_{1 - i} \vert {ϕ}_{s} ) ]$$

$$\text{?} \text{indicates text missing or illegible when filed}$$

The policy gradient is illustrated in equation (18).

$${{∇}_{θ}}_{1} \frac{1}{\vert {B}_{i} \vert} {\sum }_{\text{?}} {Q}_{i} ( {s}_{i} , {π}_{i} ( {s}_{i} , {s}_{1 - i} \vert {θ}_{i} ) , {s}_{1 - i} , {π}_{1 - i} ( {s}_{1 - i} , {s}_{i} \vert {θ}_{1 - i} ) \vert {ϕ}_{i} ) \qquad ( 18 )$$

$$= \frac{1}{\vert {B}_{i} \vert} {\sum }_{\text{?}} [ {∇}_{a} , {Q}_{i} ( {s}_{i} , {a}_{i} , {s}_{1 - i} , {a}_{1 - i} \vert {ϕ}_{i} ) \vert \text{?} {∇}_{{θ}_{i}} {π}_{i} ( {s}_{i} , {s}_{1 - i} \vert {θ}_{i} ) ]$$

$$\text{?} \text{indicates text missing or illegible when filed}$$

When direct exchange of data is not allowed, then ai, Qi, Qtarg is unable to be computed. In some implementations, the privacy preserving SECFLOAT modules are integrated to generate hybrid integrated APIs for MADDPG updates.

For party i, the updated version of Q^{targ}ᵢ and equations (17) and (18) are illustrated below in equations (19), (20), and (21).

$${Q}_{i}^{targ} = {R}_{i} + γ F - SecFloat ( {\ddot{V}}_{i}^{′} , \text{?} ) \qquad ( 19 )$$

$${∇}_{{ϕ}_{s}} L = BL - SecFloat \text{?} ( {\ddot{V}}_{i} , \text{?} , {ϕ}_{i} {Q}_{i}^{targ} \qquad ( 20 )$$

$$Policy Gradient = B - {SecFloat}_{Λ} \text{?} ( {\ddot{V}}_{i} , , {ϕ}_{i} ) ∘ B - {SecFloat}_{{θ}_{1}} ( {S}_{i} , {θ}_{i} ) \qquad ( 21 )$$

$$\text{?} \text{indicates text missing or illegible when filed}$$

In some implementations, the forward and backward pass of the neural network (e.g., the neural network 102 (FIG. 1)) is replaced with the F-SECFLOAT and B-SECFLOAT APIs, allowing the secure computations to become more accessible. For every forward and backward pass of the neural network, the data (e.g., the private data of the parties) is preprocessed once and the APIs are called once, which is unlike existing methodology where a) for every operation for clear-text a call is made to the primitive SECFLOAT APIs, which is impractical—for example, even a small feed-forward network for MADDPG can contain exponentially high primitive calls for a single matrix operation; b) additionally pre-processing of input data is required every time before invoking the APIs for each party, which adds another significant overhead programmatically.

In some implementations, Algorithm 1 is used for an iteration of the privacy preserving two-party DDPG with SECFLOAT NN APIs.

Algorithm 1: An iteration of Privacy Preserving Two-party DDPG with SecFloat NN API's

| | Input: s [symbol] , θᵢ, ϕᵢ, θ′ᵢ, ϕ′ᵢ for each Player i ∈ {0, 1} | | |
|---|---|---|---|
| | Include: SecFloat API's F-SecFloat, B-SecFloat, BL-SecFloat as described in section 3.1 | | |
| | | | of the main paper |
| 1 | for i ∈ {0, 1} do | | |
| 2 | \| | \tilde{s} [symbol] \tilde{s}₁₋ᵢ ← Input pre-processing with Batch Size 1, according to section 3.1: | |
| 3 | \| | [symbol] ← clip(F-SecFloat(\tilde{s} [symbol] , [symbol] θᵢ) + [symbol] , low, high) where [symbol] [symbol] (0, 1) and low, high are | |
| | \| | bounds: | |
| 4 | \| | s′ [symbol] ← the next state; | |
| 5 | \| | rₛ ← reward associated to the state transition; | |
| 6 | \| | (sᵢ, [symbol] , rᵢ, s′ᵢ) is stored in [symbol] [symbol] | |
| 7 | end | | |
| 8 | for i ∈ {0, 1} do | | |
| 9 | \| | Player i samples an index set [symbol] ᵢ ⊂ \| [symbol] ᵢ\| and sends [symbol] ᵢ explicitly to Player (1 − i) where \| [symbol] ᵢ\| is | |
| | \| | the batch size; | |
| 10 | \| | for j ∈ {0, 1} do | |
| 11 | \| | \| | Bⱼ ← {(sⱼ, oⱼ, rⱼ, s′ⱼ)ₖ ∈ [symbol] ⱼ} where k ∈ [symbol] [symbol] |
| 12 | \| | \| | B ← \|Bⱼ\| = \| [symbol] [symbol] \|; |
| 13 | \| | \| | Sⱼ ← stack (sⱼ) [symbol] ,..., (sⱼ) [symbol] row wise |
| 14 | \| | \| | Aⱼ, Rⱼ, S′ⱼ ← similar row-wise stacking; |
| 15 | \| | \| | Vⱼ = Sⱼ][Aⱼ; |
| 16 | \| | \| | \tilde{S}ⱼ, \tilde{V}ⱼ, \tilde{S}′ⱼ ← Input pre-processing according to section 3.1 |
| 17 | \| | end | |
| 18 | \| | for j ∈ {0, 1} do | |
| 19 | \| | \| | Estimated Next Actions; A′ⱼ ← F-SecFloat(\tilde{S} [symbol] ⱼ, [symbol] θ′ⱼ); |
| 20 | \| | \| | V′ⱼ ← S′ⱼ][A′ⱼ; V′ⱼ ← Input pre-processing; |

| | | |
|---|---|---|
| 21 | \| | end |
| 22 | \| | Qᵢ [symbol] ← Rᵢ + γ F-SecFloat(\tilde{V}ᵢ, [symbol] , ϕ′ᵢ); |
| 23 | \| | [equation 19] |
| 24 | \| | ∇ [symbol] L ← BL-SecFloat [symbol] (\tilde{V}ᵢ, [symbol] , ϕᵢ, Qᵢ [symbol] ) [equation 20]; |
| 25 | \| | ∇ [symbol] Q ← B-SecFloat [symbol] (\tilde{V}ᵢ, [symbol] , ϕᵢ); |
| 26 | \| | Policy gradient ← ∇ [symbol] Q [symbol] B-SecFloat [symbol] , (\tilde{S}ᵢ, [symbol] , θᵢ); |
| 27 | \| | [ [symbol] is element-wise product. Above 2 steps follow from equation 21] |
| 28 | \| | θi ← θᵢ + lr [symbol] [Policy gradient]; |
| 29 | \| | ϕᵢ ← ϕᵢ − lrₑ[∇ [symbol] L]; |
| 30 | \| | [lrₐ and lrₑ are actor and critic learning rates] |

| | |
|---|---|
| 31 | end |
| 32 | θ′ᵢ ← pθ′ [symbol] + (1 − ρ)θ [symbol] ; |
| 33 | ϕ′ᵢ ← pϕ′ [symbol] + (1 − ρ)ϕᵢ; |
| 34 | [Target network updates at fixed intervals with hyperparameter ρ] |

[symbol]

indicates data missing or illegible when filed

In some implementations, one or more computing devices (e.g., servers and/or devices) are used to perform the processing of the environment 300. The one or more computing devices may include, but are not limited to, server devices, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. Another example includes one or more subcomponents of the features and functionalities discussed herein in connection with the various systems may be implemented across multiple computing devices. Moreover, in some implementations, one or more subcomponent of the features and functionalities discussed herein in connection with the various systems may be implemented are processed on different server devices of the same or different cloud computing networks.

In some implementations, each of the components of the environment 300 is in communication with each other using any suitable communication technologies. In addition, while the components of the environment 300 are shown to be separate, any of the components or subcomponents may be combined into fewer components, such as into a single component, or divided into more components as may serve a particular implementation. In some implementations, the components of the environment 300 include hardware, software, or both. For example, the components of the environment 300 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 300 include hardware, such as a special purpose processing device to perform a certain function or group of functions. In some implementations, the components of the environment 300 include a combination of computer-executable instructions and hardware.

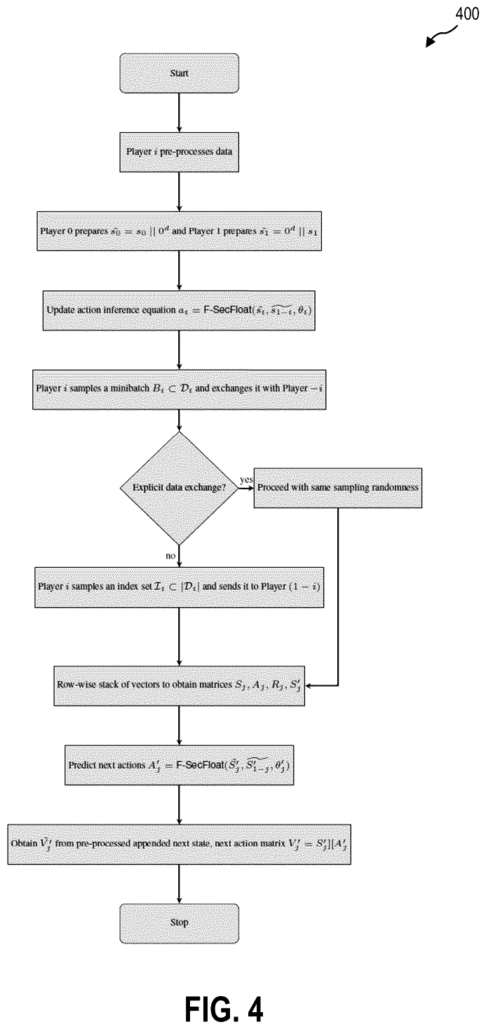

Referring now to FIG. 4, illustrated is an example method 400 for a secure MADDPG.

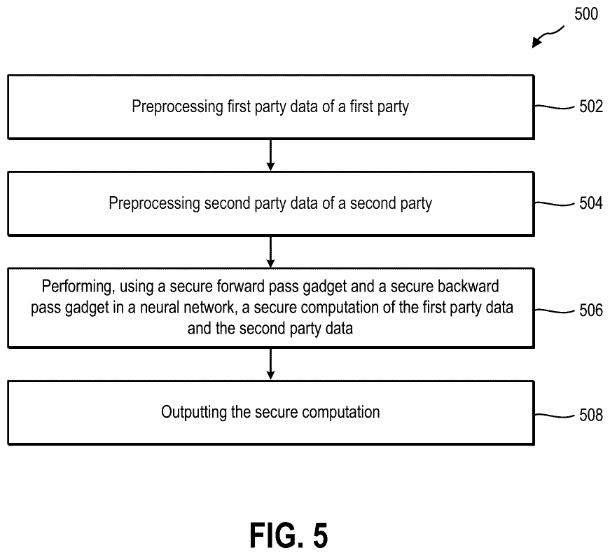

Referring now to FIG. 5, illustrated is an example method 500 for performing a secure computation. The actions of 500 are discussed in reference to FIGS. 1-3. At 502, the method 500 includes preprocessing first party data of a first party, and at 504, the method 500 includes preprocessing second party data of a second party. The neural network 102 preprocesses the first party data and the second party data. The first party data is private data of the first party and the second party data is private data of the second party. In some implementations, the first party data and the second party data are encrypted.

In some implementations, preprocessing the first party data and the second party data makes the first party data and the second party data compatible for the secure computation. In some implementations, preprocessing the first party data and the second party data enables data exchange between the first party and the second party for the secure computation while maintaining a privacy of the first party data and the second party data.

At 506, the method 500 includes performing, using a secure forward pass gadget and a secure backward pass gadget in a neural network, a secure computation of the first party data and the second party data. The neural network 102 performs a secure computation of the first party data and the second party data using a secure forward pass gadget and a secure backward pass gadget. In some implementations, the secure forward pass gadget performs, using a forward pass of the neural network, secure mathematical operations on the first party data and the second party data. In some implementations, the secure mathematical operations include one or more of matrix addition, matrix multiplication, or a comparison. In some implementations, the secure forward pass gadget performs a secure two party computation of a thirty two bit single precision floating point operations on the first party data and the second party data. In some implementations, the secure backward pass gadget performs a secure two party computation of a thirty two bit single precision floating point operations on an output of a forward pass of the neural network. In some implementations, the secure backward pass gadget updates the neural network to optimize towards a reward.

At 508, the method 500 includes outputting the secure computation. The neural network 102 outputs the secure computation. In some implementations, the first party and the second party are in a supply chain optimizing towards individual rewards. In some implementations, the method 500 further includes adjusting the supply chain in response to the secure computation. In some implementation the supply chain is a food supply chain. In some implementations, the supply chain is one of an energy market, a cloud supply chain, communication networks, or a media supply chain. In some implementations, the method 500 further includes making a decision dependent on the first party data and the second party data in response to the secure computation.

In some implementations, the method 500 further includes a plurality of additional parties in a supply chain; performing, using the secure forward pass gadget and the secure backward pass gadget in the neural network, the secure computation of data of the plurality of additional parties; and outputting the secure computation.

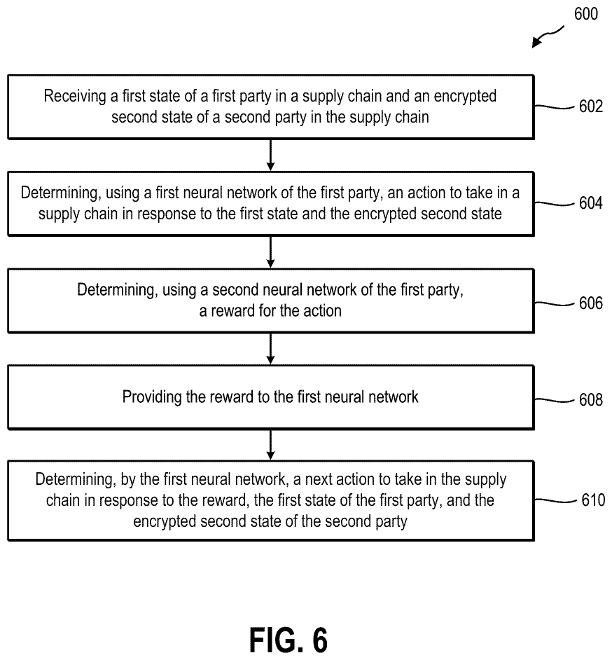

FIG. 6 illustrates an example method 600 for multi-agent reinforcement learning. The actions of the method 600 are discussed in reference to FIGS. 1-3. At 602, the method 600 includes receiving a first state of a first party in a supply chain and an encrypted second state of a second party in the supply chain. An actor neural network (FIG. 3) of the first party receives a first state of a first party in a supply chain and an encrypted second state of a second party in the supply chain.

At 604, the method 600 includes determining, using a first neural network of the first party, an action to take in a supply chain in response to the first state and the encrypted second state. The actor neural network determines an action to take in the supply chain in response to the first state and the encrypted second state. In some implementations, the encrypted second state preserves a privacy of data of the second party while allowing the first party to use the encrypted second state to determine the action.

At 606, the method 600 includes determining, using a second neural network of the first party, a reward for the action. A critic neural network (FIG. 3) of the first party determines a reward for the action. In some implementations, the reward is based on the encrypted second state of the second party.

At 608, the method 600 includes providing the reward to the first neural network. The actor network receives the reward from the critic neural network. At 610, the method 600 includes determining, by the first neural network, a next action to take in the supply chain in response to the reward, the first state of the first party, and the encrypted second state of the second party. The actor neural network determines a next action to take in the supply chain in response to the reward, the first state of the first party, and the encrypted second state of the second party. In some implementations, the first party has a first goal for the action and the second party has a second goal for the action.

In some implementations, the method 600 further includes receiving, from the first neural network, an encrypted action; determining, using a third neural network of the second party, a second action to take in the supply chain in response to the encrypted action and a second state of the second party; determining, using a fourth neural network of the second party, a second reward for the second action; providing the second reward to the third neural network; and determining, by the third neural network, another action to take in the supply chain in response to the second reward, the encrypted action, and the second state of the second party. In some implementations, the encrypted action preserves a privacy of data of the first party while allowing the second party to use the encrypted action to determine the second action.

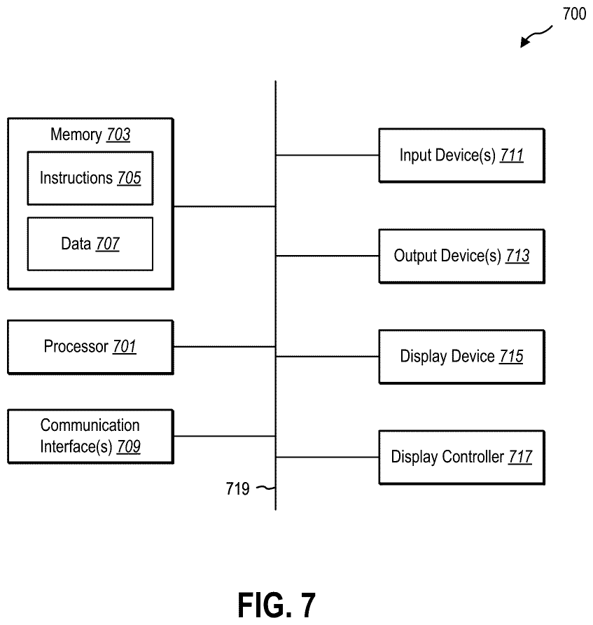

FIG. 7 illustrates components that may be included within a computer system 700. One or more computer systems 700 may be used to implement the various methods, devices, components, and/or systems described herein.

The computer system 700 includes a processor 701. The processor 701 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 701 may be referred to as a central processing unit (CPU). Although just a single processor 701 is shown in the computer system 700 of FIG. 7, in an alternative configuration, a combination of processors (e.g., an ARM and DSP) could be used.

The computer system 700 also includes memory 703 in electronic communication with the processor 701. The memory 703 may be any electronic component capable of storing electronic information. For example, the memory 703 may be embodied as random access memory (RAM), read-only memory (ROM), magnetic disk storage mediums, optical storage mediums, flash memory devices in RAM, on-board memory included with the processor, erasable programmable read-only memory (EPROM), electrically erasable programmable read-only memory (EEPROM) memory, registers, and so forth, including combinations thereof.

Instructions 705 and data 707 may be stored in the memory 703. The instructions 705 may be executable by the processor 701 to implement some or all of the functionality disclosed herein. Executing the instructions 705 may involve the use of the data 707 that is stored in the memory 703. Any of the various examples of modules and components described herein may be implemented, partially or wholly, as instructions 705 stored in memory 703 and executed by the processor 701. Any of the various examples of data described herein may be among the data 707 that is stored in memory 703 and used during execution of the instructions 705 by the processor 701.

A computer system 700 may also include one or more communication interfaces 709 for communicating with other electronic devices. The communication interface(s) 709 may be based on wired communication technology, wireless communication technology, or both. Some examples of communication interfaces 709 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 700 may also include one or more input devices 711 and one or more output devices 713. Some examples of input devices 711 include a keyboard, mouse, microphone, remote control device, button, joystick, trackball, touchpad, and lightpen. Some examples of output devices 713 include a speaker and a printer. One specific type of output device that is typically included in a computer system 700 is a display device 715. Display devices 715 used with embodiments disclosed herein may utilize any suitable image projection technology, such as liquid crystal display (LCD), light-emitting diode (LED), gas plasma, electroluminescence, or the like. A display controller 717 may also be provided, for converting data 707 stored in the memory 703 into text, graphics, and/or moving images (as appropriate) shown on the display device 715.

In some implementations, the various components of the computer system 700 are implemented as one device. For example, the various components of the computer system 700 are implemented in a mobile phone or tablet. Another example includes the various components of the computer system 700 implemented in a personal computer.

The various components of the computer system 700 may be coupled together by one or more buses, which may include a power bus, a control signal bus, a status signal bus, a data bus, etc. For clarity, the various buses are illustrated in FIG. 7 as a bus system 719.

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a classification model, a clustering model, a regression model, a language model, an object detection model) that can be tuned (e.g., trained) based on training input to approximate unknown functions. For example, a machine learning model may refer to a neural network (e.g., a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, implementations of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, a datastore, or another data structure), ascertaining and the like. Also, “determining” can include receiving (e.g., receiving information), accessing (e.g., accessing data in a memory) and the like. Also, “determining” can include resolving, selecting, choosing, establishing, predicting, inferring, and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
preprocessing first party data of a first party;
preprocessing second party data of a second party;
performing, using a secure forward pass gadget and a secure backward pass gadget in a neural network, a secure computation of the first party data and the second party data; and
outputting the secure computation.

2. The method of claim 1, wherein the secure forward pass gadget performs, using a forward pass of the neural network, secure mathematical operations on the first party data and the second party data.

3. The method of claim 2, wherein the secure mathematical operations include one or more of matrix addition, matrix multiplication, or a comparison.

4. The method of claim 1, wherein the secure forward pass gadget performs a secure two party computation of a thirty two bit single precision floating point operations on the first party data and the second party data.

5. The method of claim 1, wherein the secure backward pass gadget performs a secure two party computation of a thirty two bit single precision floating point operations on an output of a forward pass of the neural network.

6. The method of claim 1, wherein the secure backward pass gadget updates the neural network to optimize towards a reward.

7. The method of claim 1, wherein the first party data is private data of the first party and the second party data is private data of the second party.

8. The method of claim 1, wherein preprocessing the first party data and the second party data makes the first party data and the second party data compatible for the secure computation.

9. The method of claim 1, wherein preprocessing the first party data and the second party data enables data exchange between the first party and the second party for the secure computation while maintaining a privacy of the first party data and the second party data.

10. The method of claim 1, wherein the first party and the second party are in a supply chain optimizing towards individual rewards and the method further comprises:
adjusting the supply chain in response to the secure computation.

11. The method of claim 10, wherein the supply chain is a food supply chain.

12. The method of claim 10, wherein the supply chain is one of an energy market, a cloud supply chain, communication networks, or a media supply chain.

13. The method of claim 1, further comprising:
making a decision dependent on the first party data and the second party data in response to the secure computation.

14. The method of claim 1, further comprising:
a plurality of additional parties in a supply chain;
performing, using the secure forward pass gadget and the secure backward pass gadget in the neural network, the secure computation of data of the plurality of additional parties; and
outputting the secure computation.

15. A method, comprising:
receiving a first state of a first party in a supply chain and an encrypted second state of a second party in the supply chain;
determining, using a first neural network of the first party, an action to take in a supply chain in response to the first state and the encrypted second state;
determining, using a second neural network of the first party, a reward for the action;
providing the reward to the first neural network; and
determining, by the first neural network, a next action to take in the supply chain in response to the reward, the first state of the first party, and the encrypted second state of the second party.

16. The method of claim 15, wherein the first party has a first goal for the action and the second party has a second goal for the action.

17. The method of claim 15, wherein the encrypted second state preserves a privacy of data of the second party while allowing the first party to use the encrypted second state to determine the action.

18. The method of claim 15, wherein the reward is based on the encrypted second state of the second party.

19. The method of claim 15, further comprising:
receiving, from the first neural network, an encrypted action;
determining, using a third neural network of the second party, a second action to take in the supply chain in response to the encrypted action and a second state of the second party;
determining, using a fourth neural network of the second party, a second reward for the second action;
providing the second reward to the third neural network; and
determining, by the third neural network, another action to take in the supply chain in response to the second reward, the encrypted action, and the second state of the second party.

20. The method of claim 19, wherein the encrypted action preserves a privacy of data of the first party while allowing the second party to use the encrypted action to determine the second action.
